(19) United States
(12) Patent Application Publication
(10) Pub. No.: US 2025/0295091 A1
(43) Pub. Date: Sep. 25, 2025

(54) PET HOME SYSTEM

(71) Applicant: Jennifer Preville, Lapeer, MI (US)

(72) Inventor: Jennifer Preville, Lapeer, MI (US)

(21) Appl. No.: 18/611,313

(22) Filed: Mar. 20, 2024

(51) Int. Cl. A01K 1/03; A01K 1/015

(52) U.S. Cl. CPC A01K 1/03

(57) ABSTRACT

A pet home system for housing and entertaining a small pet includes a tank and a tray that is removably positionable in the tank. A magnet is coupled to the tray. A house is releasably couplable to the tray. The house is positionable within the tank when the house is coupled to the tray and when the tray is positioned in the tank. The house has a height that is smaller than a height of the tank wherein the house is designed to provide a living space for a small animal within the tank while inhibiting the small animal from escaping the tank. The house is magnetic wherein the house is magnetically attracted to the magnet and magnetically secured to the tray.

### CROSS-REFERENCE TO RELATED APPLICATIONS

### Not Applicable

### STATEMENT REGARDING FEDERALLY SPONSORED RESEARCH OR DEVELOPMENT

### Not Applicable

### THE NAMES OF THE PARTIES TO A JOINT RESEARCH AGREEMENT

### Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

### Not Applicable

### STATEMENT REGARDING PRIOR DISCLOSURES BY THE INVENTOR OR JOINT INVENTOR

### Not Applicable

### BACKGROUND OF THE INVENTION

### (1) Field of the Invention

The disclosure relates to pet homes and more particularly pertains to a new pet home for housing and entertaining a small pet.

### (2) Description of Related Art Including Information Disclosed Under 37 CFR 1.97 and 1.98

The prior art relates to pet homes. Myriad pet homes have been disclosed and designed. For example, the prior art discloses aquariums for aquatic pets such as fish, terrariums for insects and reptiles, and kennels for larger mammals such as cats or dogs. However, these pet homes can be difficult to clean because the pets need to be completely removed from the home whenever the aquarium, terrarium, or kennel needs to be washed. The prior art also discloses various decorations that can be used to customize the appearance of the pet homes or to entertain the pet living in the pet home. These decorations can make cleaning the pet homes even more difficult. Thus, there is a need in the art for a sturdy, safe pet home that can be customized according to the user's preferences, which can provide entertainment for the pet, and that can be easily disassembled for cleaning.

### BRIEF SUMMARY OF THE INVENTION

An embodiment of the disclosure meets the needs presented above by generally comprising a tank and a tray that is removably positionable in the tank. A magnet is coupled to the tray. A house is releasably couplable to the tray. The house is positionable within the tank when the house is coupled to the tray and when the tray is positioned in the tank. The house has a height that is smaller than a height of the tank wherein the house is designed to provide a living space for a small animal within the tank while inhibiting the small animal from escaping from the tank. The house is magnetic wherein the house is magnetically attracted to the magnet that is coupled to the tray whereby the house is magnetically secured to the tray.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a pet home system according to an embodiment of the disclosure.

FIG. 2 is a front view of an embodiment of the disclosure.

FIG. 3 is a front isometric view of an embodiment of the disclosure.

FIG. 4 is an exploded view of an embodiment of the disclosure.

FIG. 5 is a cross-sectional view of an embodiment of the disclosure.

FIG. 6 is a cross-sectional view of an embodiment of the disclosure.

### DETAILED DESCRIPTION OF THE INVENTION

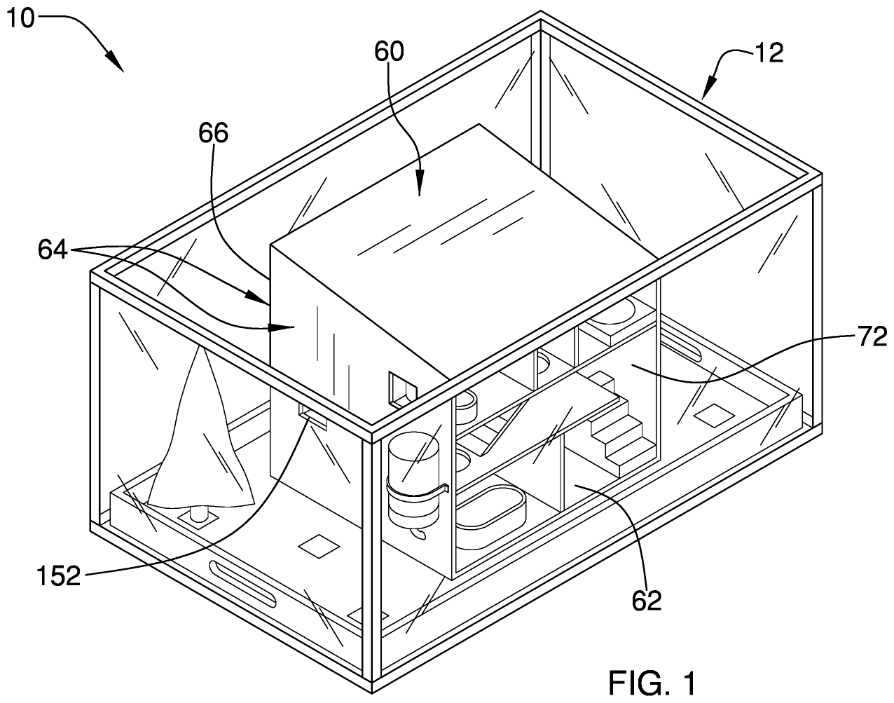

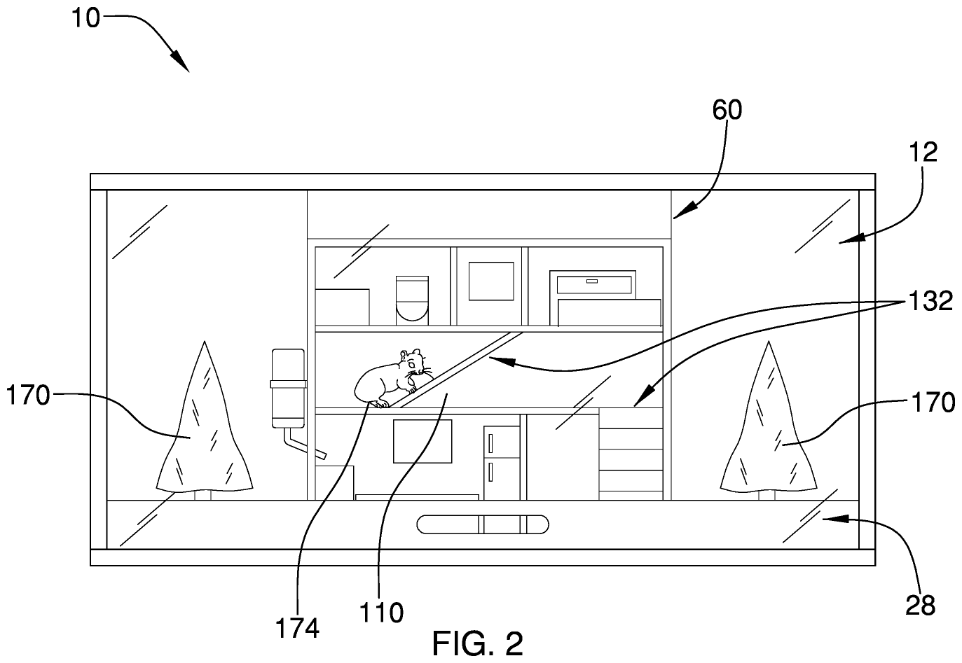

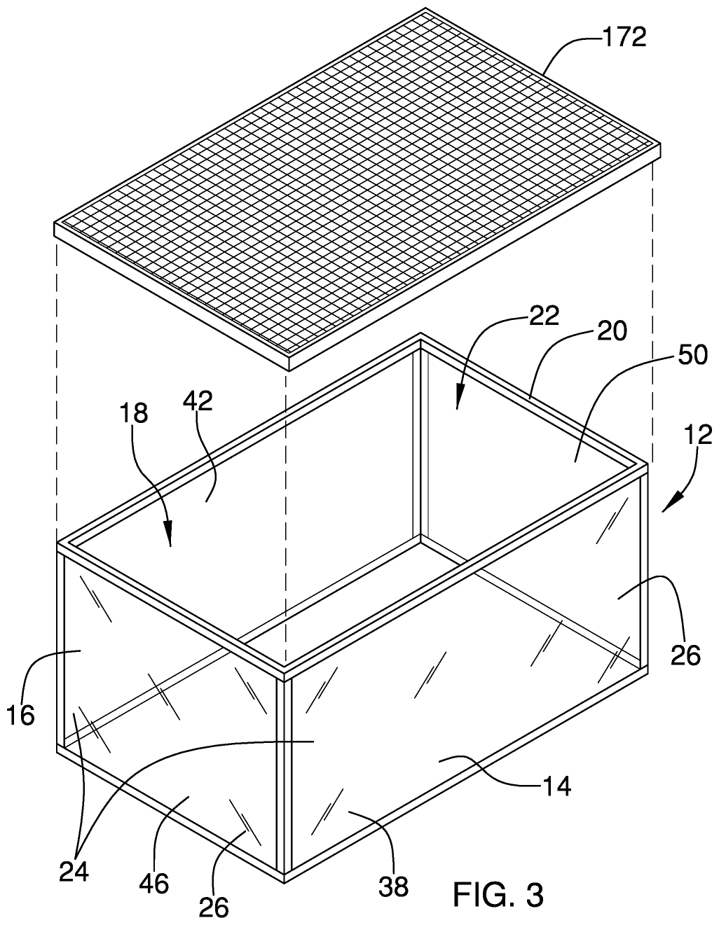

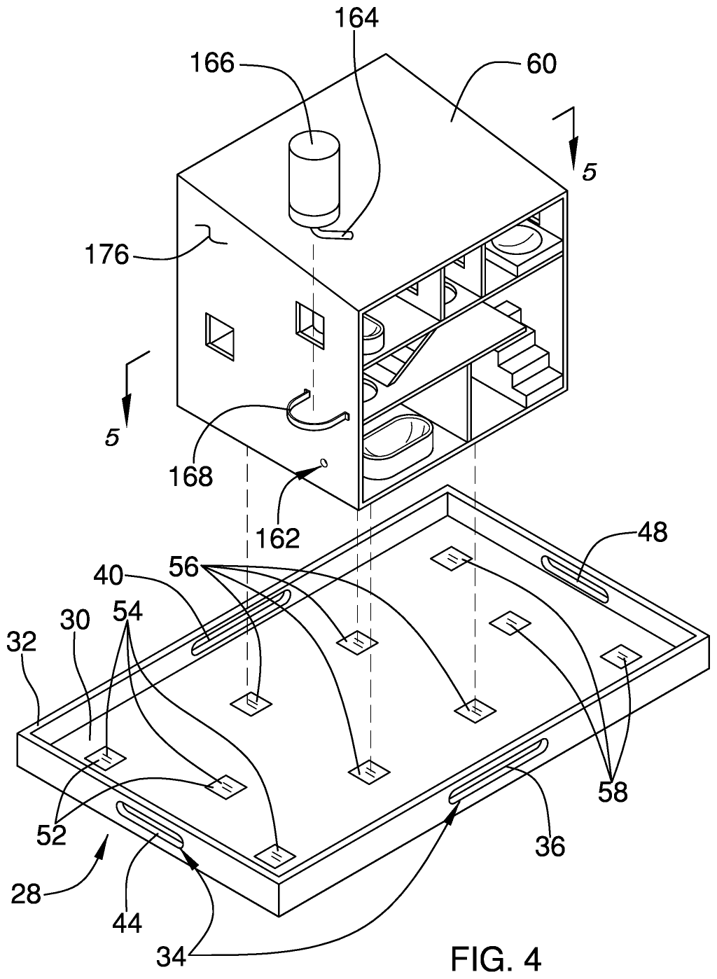

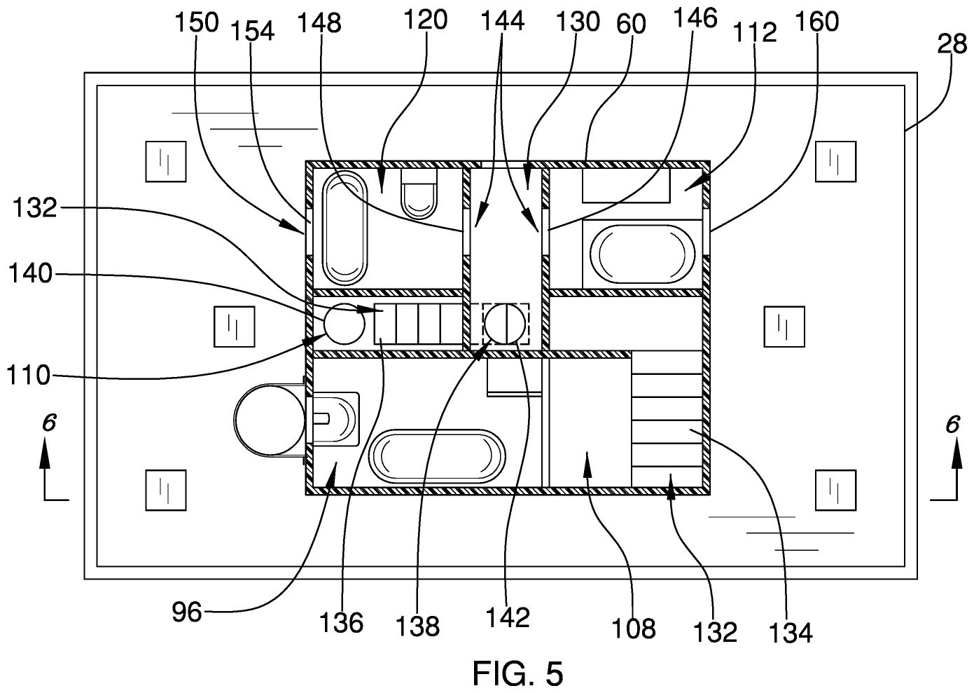

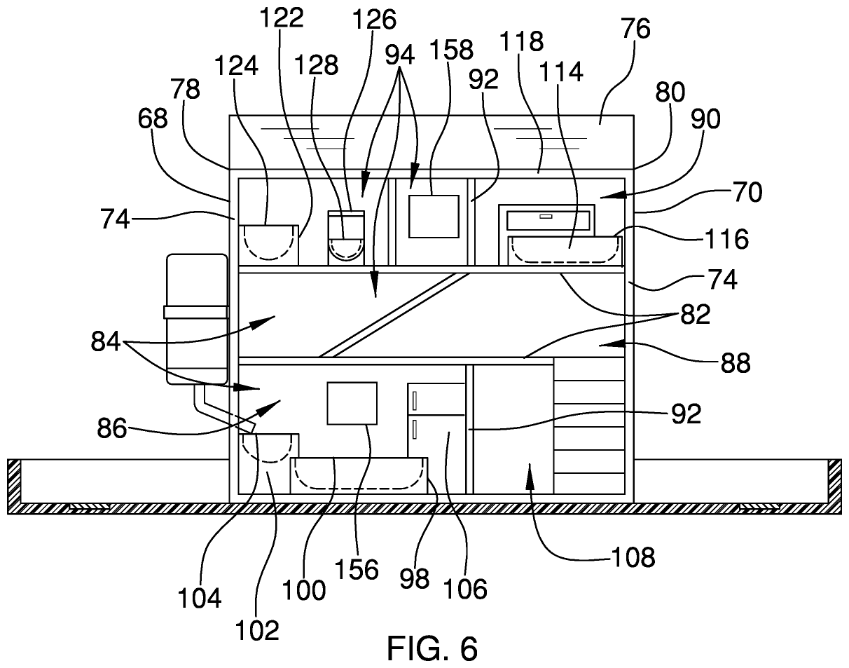

With reference now to the drawings, and in particular to FIGS. 1 through 6 thereof, a new pet home embodying the principles and concepts of an embodiment of the disclosure and generally designated by the reference numeral 10 will be described.

As best illustrated in FIGS. 1 through 6, the pet home system 10 generally comprises a tank 12. For example, the tank 12 may have a base wall 14 and a peripheral wall 16 that is coupled to and extends upwardly from the base wall 14 to define an interior space 18. The peripheral wall 16 may have an upper edge 20 that defines an opening 22 into the interior space 18. The peripheral wall 16 may have a first pair of lateral ends 24 and a second pair of lateral ends 26. The first pair of lateral ends 24 may have a length exceeding a length of the second pair of lateral ends 26, such that the tank 12 is rectangular as shown in the Figures. In alternative embodiments, the tank 12 may have an alternative shape. Generally, the peripheral wall 16 is transparent wherein the peripheral wall 16 is designed to facilitate visibility into the interior space 18.

A tray 28 is removably positionable on the base wall 14 of the tank 12. The tray 28 generally includes a bottom panel 30 and a lip 32 may be coupled to and extend upwardly from the bottom panel 30. The bottom panel 30 generally has a size that is complementary to the size of the base wall 14 of the tank 12 wherein the tray 28 covers an entirety of the base wall 14 when the tray 28 is positioned in on the base wall 14 of the tank 12. The lip 32 may have a width between 0.5 inch and 1.5 inches.

A plurality of cutouts 34 may extend through the lip 32. The plurality of cutouts 34 is designed to facilitate a user in gripping the tray 28 to position the tray 28 in the interior space 18 of the tank 12 and to remove the tray 28 from the interior space 18 of the tank 12. Each cutout of the plurality of cutouts 34 is generally spaced from an adjacent cutout of the plurality of cutouts 34. Each cutout of the plurality of cutouts 34 may be centered on a respective side of the lip 32, wherein each cutout of the plurality of cutouts 34 may be opposite and aligned with another cutout across the bottom panel 30. For example, the plurality of cutouts 34 may include a first cutout 36 that is positioned proximate to a first lateral end 38 of the first pair of lateral ends 24 of the peripheral wall 16 of the tank 12 when the tray 28 is positioned on the base wall 14 of the tank 12. A second cutout 40 may be positioned proximate to a second lateral end 42 of the first pair of lateral ends 24 of the peripheral wall 16 of the tank 12 when the tray 28 is positioned on the base wall 14 of the tank 12. A third cutout 44 may be positioned proximate to a primary lateral end 46 of the second pair of lateral ends 26 of the peripheral wall 16 of the tank 12 when the tray 28 is positioned on the base wall 14 of the tank 12. A fourth cutout 48 may be positioned proximate to a secondary lateral end 50 of the second pair of lateral ends 26 of the tank 12 when the tray 28 is positioned on the base wall 14 of the tank 12.

A plurality of magnets 52 is coupled to the bottom panel 30 of the tray 28. The plurality of magnets 52 is generally spread across the bottom panel 30 so that the plurality of magnets 52 can retain magnetic objects across the bottom panel 30. For example, the plurality of magnets 52 may be arranged such that the entire bottom panel 30 is magnetic, or such that sections of the bottom panel 30 are magnetic. For example, the plurality of magnets 52 may be arranged in a first lateral grouping 54, a central grouping 56, and a second lateral grouping 58. The central grouping 56 is positioned between the first lateral grouping 54 and the second lateral grouping 58 wherein the central grouping 56 is centrally positioned on the bottom panel 30 of the tray 28. The first lateral grouping 54 is positioned proximate to the primary lateral end 46 of the second pair of lateral ends 26 of the peripheral wall 16 of the tank 12 while the tray 28 is positioned on the base wall 14 of the tank 12. The second lateral grouping 58 is positioned proximate to the secondary lateral end 50 of the second pair of lateral ends 26 of the peripheral wall 16 of the tank 12 when the tray 28 is positioned on the base wall 14 of the tank 12.

A house 60 is releasably couplable to the tray 28. The house 60 is positionable within the interior space 18 of the tank 12 when the house 60 is coupled to the tray 28 and when the tray 28 is positioned in the interior space 18. The house 60 generally has a height that is smaller than a height of the peripheral wall 16 of the tank 12 wherein the house 60 is designed to provide a living space for a small animal 174 within the tank 12. In this context, the small animal 174 is an animal that fits within the interior space 18 of the tank 12 wherein the tank 12 is designed to provide adequate living space for the small animal 174. Different species of the small animal 174 may require different sizes of the tank 12 for adequate living space, and the size of the house 60 may vary accordingly. For example, the small animal 174 may be a pet such as a hamster, a gerbil, a chinchilla, a frog, or a fish.

The house 60 generally includes a floor 62 that is positionable to rest on the tray 28. The floor 62 is releasably couplable to the bottom panel 30 of the tray 28. The floor 62 is generally parallel to the bottom panel 30 of the tray 28 when the house 60 is coupled to the tray 28. The floor 62 is generally magnetic wherein the floor 62 is magnetically attracted at least one of the plurality of magnets 52 whereby the house 60 is magnetically secured to the tray 28 when the floor 62 is positioned to rest on the tray 28. The floor 62 may be magnetically attracted to more than one of magnets of the plurality of magnets 52 wherein the floor 62 is adjustably positionable on the tray 28. For example, the central grouping 56 of the plurality of magnets 52 may be arranged to mirror a shape of the floor 62 wherein the floor 62 is designed to be magnetically secured to the central grouping 56 of the plurality of magnets 52 whereby the house 60 is centrally positionable on the tray 28 and whereby each of the first lateral grouping 54 and the second lateral grouping 58 of the plurality of magnets 52 is laterally spaced from the house 60 when the floor 62 is coupled to the tray 28.

The house 60 generally includes a plurality of sides 64 that is coupled to and extends upwardly from the floor 62. Each side of the plurality of sides 64 may be perpendicular to the floor 62. The plurality of sides 64 may include a back side 66 that is generally parallel to the first pair of lateral ends 24 of the tank 12 when the house 60 is positioned within the interior space 18. A first side 68 may be coupled to and extend outwardly from the back side 66. The first side 68 may be perpendicular to the back side 66. The first side 68 may be parallel to the second pair of lateral ends 26 of the tank 12 when the house 60 is positioned within the interior space 18. A second side 70 may be coupled to and extend outwardly from the back side 66. The second side 70 may be perpendicular to the back side 66. The second side 70 may be parallel to the first side 68, and generally the second side 70 is spaced from the first side 68.

A front side 72 of the house 60 may be open to facilitate access and visibility into the house 60. For example, the front side 72 may have a pair of forward edges 74 that is positioned on opposed sides of the front side 72. The pair of forward edges 74 may be coplanar with each other. The pair of forward edges 74 may be parallel to the back side 66.

A roof 76 is generally coupled to and extends between the plurality of sides 64. The roof 76 is distally positioned on the plurality of sides 64 relative to the floor 62. The roof 76 may be perpendicular to each side of the plurality of sides 64.

The roof 76 may be planar, as shown in the figures, or the roof 76 may have an alternative design. For example, alternative embodiments of the roof 76 may include a gabled roof, a hip roof, a butterfly roof, a mansard roof, or any other design according to the preferences of the user. As stated above, the house 60 is generally shorter than the peripheral wall 16, so the apex peak of the roof 76 is generally positioned below the upper edge 20 of the peripheral wall. The relative heights of the house 60 and the roof 76 are configured to inhibit the small animal 174 from escaping the tank 12 by climbing on the roof 76.

The first side 68 of the plurality of sides 64 may have a first top edge 78. The second side 70 may have a second top edge 80. The first top edge 78 may be coplanar with the second top edge 80. Each of the first top edge 78 and the second top edge 80 may be angled relative to the floor 62 wherein the roof 76 is angled downwardly between the back side 66 and the front side 72 and wherein the back side 66 has a height exceeding a height of the front side 72. Alternatively, each of the first top edge 78 and the second top edge 80 may be angled relative to the floor 62 wherein the roof 76 is angled upwardly between the back side 66 and the front side 72 and wherein the back side 66 has a height that is smaller than a height of the front side 72. As discussed above, alternative configurations and designs of the roof 76 are also contemplated.

A plurality of interior floors 82 may be coupled to and extend between the plurality of sides 64 to define a plurality of levels 84 within the house 60. For example, the plurality of levels 84 may include a first level 86 that is positioned adjacent to the floor 62, a second level 88 that is positioned above the first level 86, and a third level 90 that is positioned above the second level 88. For example, the third level 90 may be positioned adjacent to the roof 76. Alternative embodiments may include alternative configurations of the plurality of levels 84. The plurality of levels 84 is generally configured to provide entertainment and exploration opportunities for the small animal 174 living within the tank 12.

A plurality of interior walls 92 is generally coupled to and extends between the floor 62, the plurality of interior floors 82, and the roof 76 to define a plurality of rooms 94 within the house 60. Each interior wall of the plurality of interior walls 92 may be perpendicular to the plurality of interior floors 82. The plurality of rooms 94 is arranged on the plurality of levels 84 wherein each level of the plurality of levels 84 includes at least one room of the plurality of rooms 94. The plurality of rooms 94 is generally configured to provide entertainment and exploration opportunities for the small animal 174 and is also generally configured to facilitate the small animal 174 in receiving daily necessities such as food, water, and comfortable nesting or resting areas.

For example, the plurality of rooms 94 may include a kitchen 96. The kitchen 94 may be positioned on the first level 86. The kitchen 96 may include a food bowl 98. The food bowl 98 may be concavely arcuate across an upper surface 100 wherein the food bowl 98 is designed to hold food for the small animal 174. The food bowl 98 may be table shaped wherein the food bowl 98 is designed to resemble a working kitchen table, or a kitchen table in a person's home. Alternatively, the food bowl 98 may be table shaped wherein the food bowl 98 is designed to be decorative and provide a climbing structure for the small animal 174.

The kitchen 96 may also include a sink 102. The sink 102 may be decorative, to provide a climbing structure for the small animal 174. Alternatively, the sink 102 may be concavely arcuate across a top surface wherein the sink 102 is designed to hold a fluid. The sink 102 may be positioned against the first side 68, or another one of the plurality of sides 64 of the house 60.

A decorative refrigerator 106 may be positioned in the kitchen 96, for example against the back side 66 of the house 60. The decorative refrigerator 106 is designed to resemble a working refrigerator wherein the kitchen 96 is designed to represent a working kitchen. In other words, the decorative refrigerator 106 may be designed to resemble a refrigerator in a person's home, such that the kitchen 96 resembles the person's kitchen.

The food bowl 98, sink 102, and decorative refrigerator 106 106 may be affixed to the house 60, or may be removably positionable within the house 60. In some embodiments, the food bowl 98, sink 102, and decorative refrigerator 106 106 are each releasably couplable to the house 60 to facilitate removal of the food bowl 98 and sink 102 for cleaning.

An entryway 108 may be positioned on the first level 86 adjacent to the kitchen 96. A living room 110 may be positioned on the second level 88.

A bedroom 112 may be positioned on the third level 90. The bedroom 112 may include a bed 114. The bed 114 may be decorative, to provide a climbing structure for the small animal 174. Alternatively, the bed 114 may be concavely arcuate across an uppermost surface 116 wherein the bed 114 is designed to hold a bedding material for the small animal 174. The bed 114 generally has a size that is designed to complement a size of the small animal 174 wherein the bed 114 is designed to hold the small animal 174 while the small animal 174 is resting on the bedding.

The bedroom 112 may include a decorative dresser 118, for example positioned against the back side 66. The decorative dresser 118 is generally designed to resemble a working dresser wherein the bedroom 112 is designed to represent a working bedroom. Like the kitchen, the decorative dresser 118 may be designed to resemble or represent a person's dresser in the person's bedroom, such that the house 60 for the small animal 174 resembles the person's home.

A bathroom 120 may be positioned on the third level 90. The bathroom 120 may include a bathtub 122. The bathtub 122 may be decorative. Alternatively, the bathtub may be concavely arcuate across a topmost surface 124 wherein the bathtub 122 is designed to hold the bedding material for the small animal 174. The bathtub 122 generally has a size that is designed to complement the small animal 174 wherein the bathtub 122 is designed to hold the small animal 174 while the small animal 174 is resting on the bedding. In other embodiments, instead of bedding, the bathtub 122 could hold sand that the small animal 174 uses for a sand bath, for example when the small animal 174 is a hamster.

The bathroom 120 may also include a toilet 126 with a toilet bowl 128. The toilet 126 may be decorative. Alternatively, the toilet bowl 128 may be concavely arcuate wherein the toilet 126 is designed to hold food, bedding, or a treat for the small animal 174.

A hallway 130 may be positioned on the third level 90 between the bedroom 112 and the bathroom 120.

A plurality of staircases 132 may be coupled to and extend between the plurality of interior floors 82. The plurality of staircases 132 extend between the plurality of levels 84 wherein the plurality of staircases 132 is designed to facilitate the small animal 174 in traveling between each of the plurality of levels 84. For example, a first level staircase 134 may extend between the first level 86 and the second level 88. As shown in the Figures, the first level staircase 134 may extending upwardly from the entryway 108 to the living room 110. A second level staircase 136 may extend between the second level 88 and the third level 90. As shown in the figures, the second level staircase 136 extends upwardly from the living room 110 to the hallway 130.

A plurality of holes 138 may extend through the plurality of interior floors 82. Each hole of the plurality of holes 138 generally has a size that is complementary to the size of the small animal 174 wherein the plurality of holes 138 is designed to facilitate the small animal 174 in moving between the plurality of levels 84.

For example, a kitchen hole 140 may be positioned on the second level 88 above the kitchen 96 wherein the kitchen hole 140 is designed to facilitate the small animal 174 in moving between the kitchen 96 and the living room 110. The kitchen hole 140 may be positioned proximate to the second level staircase 136 wherein the kitchen hole 140 is designed to facilitate the small animal 174 in accessing the kitchen 96 when the small animal 174 is descending the second level staircase 136.

A hallway hole 142 may be positioned on the third level 90 within the hallway 130. The hallway hole 142 may be positioned proximate to the second level staircase 136 wherein the hallway hole 142 is designed to facilitate the small animal 174 in accessing the second level staircase 136 from the hallway and wherein the hallway hole 142 is designed to facilitate the small animal 174 in moving between the hallway 130 and the living room 110.

A plurality of doorways 144 may extend through the plurality of interior walls 92. The plurality of doorways 144 generally extend between two rooms of the plurality of rooms 94 wherein the plurality of doorways 144 is designed to facilitate the small animal 174 in moving between the two rooms of the plurality of rooms 94.

For example, a bedroom doorway 146 may be positioned on the third level 90. The bedroom doorway 146 may extend between the hallway 130 and the bedroom 112 wherein the bedroom doorway 146 is designed to facilitate the small animal 174 in moving between the hallway 130 and the bedroom 112.

A bathroom doorway 148 may be positioned on the third level 90. The bathroom doorway 148 may extend between the hallway 130 and the bathroom 120 wherein the bathroom doorway 148 is designed to facilitate the small animal 174 in moving between the hallway 130 and the bathroom 120.

A plurality of windows 150 may extend through the plurality of sides 64 of the house 60. As shown in the figures, each window of the plurality of windows 150 is rectangular, but in alternative embodiments each window of the plurality of windows 150 may have an alternative shape. For example, the plurality of windows 150 may be circular or hexagonal. In some embodiments, each window of the plurality of windows 150 has a unique shape. Each window of the plurality of windows 150 may have a size that is complementary to the size of the small animal 174 wherein the plurality of windows 150 is designed to facilitate the small animal 174 in crawling through the plurality of windows 150. The plurality of windows 150 may be positioned on the first side 68, the back side 66, and the second side 70, as shown in the Figures. In other embodiments, one or more windows of the plurality of windows 150 may also be positioned on the roof 76 wherein the plurality of windows 150 is designed to resemble a skylight and to facilitate the small animal 174 in climbing onto the roof 76.

For example, a living room window 152 may extend through the first side 68. The living room window 152 is positioned in the living room 110. A bathroom window 154 may extend through the first side 68. The bathroom window 154 is positioned in the bathroom 120. A kitchen window 156 may extend through the back side 66. The kitchen window 156 is positioned in the kitchen 96. A hallway window 158 may extend through the back side 66. The hallway window 158 is positioned in the hallway 130. A bedroom window 160 may extend through the second side 70. The bedroom window 160 is positioned in the bedroom 112.

The design and configuration of the house 60 may be adjusted based on preferences of the user. For example, the user may desire to include a fourth level, to decorate the living room 110 to resemble a media room, or to put the bedroom 112 on the first floor 62 instead of the third floor 62. In another example, the house 60 may be designed and designed to mirror the home of the user. Different embodiments may therefore include alternative arrangements of various features such as the plurality of sides 64, the plurality of interior floors 82, the plurality of interior walls 92, the plurality of rooms 94, the plurality of staircases 132, the plurality of holes 138, the plurality of doorways 144, and the plurality of windows 150.

The pet home system 10 may further include an aperture 162 extending through one side of the plurality of sides 64 of the house 60. For example, the aperture 162 may extend through the first side 68 into the kitchen 96. In such embodiments, the aperture 162 is generally aligned with the sink 102 wherein the aperture 162 is positioned above the sink 102. The aperture 162 is designed to receive a spout 164 of a water bottle 166 wherein the sink 102 is designed to retain the fluid within the concavely arcuate top surface 104 when the fluid drips outwardly through the spout 164 from the water bottle 166. In other embodiments, the aperture 162 may extend into the bathroom 120. For example, the aperture 162 may be aligned with and positioned above the bathtub 122 such that the bathtub 122 is designed to retain the fluid that drips outwardly through the spout 164 from the water bottle 166.

A retainer 168 may be coupled to an exterior surface 176 of the house 60. The retainer 168 generally extends outwardly from the exterior surface 176 of the house 60 wherein the retainer 168 is designed to secure the water bottle 166 against the house 60. The retainer 168 may be positioned on the first side 68 of the plurality of sides 64 of the house 60 above the aperture 162 extending through the first side 68 wherein the retainer 168 is designed to receive the water bottle 166 such that the spout 164 is positionable through the aperture 162.

A plurality of yard decorations 170 may be positionable to rest on the tray 28. Each yard decoration of the plurality of yard decorations 170 generally has a height that is smaller than a height of the peripheral wall 16 of the tank 12 wherein the plurality of yard decorations 170 is designed to provide entertainment and climbing structures for the small animal 174 within the tank 12 while inhibiting the small animal 174 from escaping the tank 12 through the opening 22.

The plurality of yard decorations 170 may be releasably couplable to the bottom panel 30 of the tray 28. For example, each yard decoration of the plurality of yard decorations 170 may be magnetic wherein each yard decoration of the plurality of yard decorations 170 is magnetically attracted to at least one magnet of the plurality of magnets 52 whereby each yard decoration of the plurality of yard decorations 170 is magnetically secured to the tray 28.

Each yard decoration of the plurality of yard decorations 170 may be magnetically attracted more than one magnet of the plurality of magnets 52 wherein each yard decoration of the plurality of yard decorations 170 is adjustably positionable on the tray 28. For example, the plurality of yard decorations 170 may be magnetically attracted to the first lateral grouping 54 and the second lateral grouping 58 of the plurality of magnets 52 wherein each yard decoration of the plurality of yard decorations 170 is positionable outside of the house 60 when the house 60 is coupled to the central grouping 56 of the plurality of magnets 52.

The figures show that the plurality of yard decorations 170 resemble trees. In alternative embodiments, each yard decoration of the plurality of yard decorations 170 may have an alternative shape or design. For example, various alternative yard decorations may resemble a bicycle, a swing set, a park bench, or a water feature such as a pond or a fountain. Like the house 60, the plurality of yard decorations 170 can be designed to accommodate the personal preferences of the user, or to mirror the features and decorations in the yard of the user's home, or to represent features and decorations the user desires in their own home. This personalization may facilitate the user in forming a close bond with the small animal 174, as the user observes the small animal 174 enjoying features and amenities that the user can find in their own living spaces, or that the user desires to find in their own living spaces.

A lid 172 may be removably positionable over the upper edge 20 of the peripheral wall 16 of the tank 12. The lid 172 covers the opening 22 when the lid 172 is positioned over the upper edge 20 of the peripheral wall 16 wherein the lid 172 is designed to inhibit the small animal 174 from exiting the tank 12 through the opening 22. The lid 172 may be foraminous wherein the lid 172 is configured to facilitate airflow through the tank 12 while inhibiting the small animal 174 from escaping.

The figures show that the plurality of magnets 52 includes ten discrete magnets arranged across the bottom panel 30. In other embodiments, the plurality of magnets 52 may comprise a single magnet that is coupled to the bottom panel 30 of the tray 28. The single magnet may extend across the bottom panel 30, for example being coextensive with the bottom panel 30 such that the entire bottom panel 30 is magnetic. In other embodiments, the bottom panel 30 itself may be magnetic and generally has a polarity that is complementary to the floor 62 of the house 60 and the plurality of yard decorations 170. For example, the bottom panel 30 may comprise a magnetically active material that is magnetically attracted to the floor 62 of the house 60 and the plurality of yard decorations 170 so that the house 60 and the plurality of yard decorations 170 are magnetically retained on the bottom panel 30 of the tray 28.

In use, the house 60 and the plurality of yard decorations 170 can provide an entertaining living space for a wide range of pets and small animal 174s. The tank 12 may also be filled with water, for example when the small animal 174 is a fish. The house 60 and the plurality of yard decorations 170 can be designed according to the type of small animal 174 living inside the tank 12 and according to the preferences of the user. For example, smaller embodiments can be provided for smaller pets, such as dwarf hamsters while larger embodiments may be provided for larger pets, such as guinea pigs. Because the house 60 can be removed from the tray 28, and the tray 28 can be removed from the tank 12, the pet home system 10 is easy to clean and transport.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A pet home assembly comprising:
a tank;
a tray being removably positionable in the tank:
a magnet being coupled to the tray; and
a house being releasably couplable to the tray, the house being positionable within the tank when the house is coupled to the tray and when the tray is positioned in the tank, the house having a height being smaller than a height of the tank wherein the house is configured to provide a living space for a small animal within the tank, the house being magnetic wherein the house is magnetically attracted to the magnet being coupled to the tray whereby the house is magnetically secured to the tray.

2. The pet home assembly of claim 1, wherein the tank has a base wall and a peripheral wall being coupled to and extending upwardly from the base wall to define an interior space, the peripheral wall having an upper edge defining an opening into the interior space, further comprising a lid being removably positionable over the upper edge of the peripheral wall of the tank, the lid covering the opening when the lid is positioned over the upper edge of the peripheral wall wherein the lid is configured to inhibit the small animal from exiting the tank through the opening.

3. The pet home assembly of claim 1, the tray further comprising:
a bottom panel;
a lip being coupled to and extending upwardly from the bottom panel; and
a plurality of cutouts extending through the lip, the plurality of cutouts being configured to facilitate a user in gripping the tray to position the tray in the tank.

4. The pet home assembly of claim 1, the house further comprising:
a floor being positionable to rest on the tray, the floor being magnetic wherein the floor is magnetically attracted the magnet whereby the house is magnetically secured to the tray when the floor is positioned to rest on the tray;
a plurality of sides being coupled to and extending upwardly from the floor; and
a roof being coupled to and extending between the plurality of sides, the roof being distally positioned on the plurality of sides relative to the floor.

5. The pet home assembly of claim 4, the plurality of sides comprising:
a back side;
a first side being coupled to and extending outwardly from the back side;
a second side being coupled to and extending outwardly from the back side, the second side being spaced from the first side; and
a front side being open to facilitate access and visibility into the house.

6. The pet home assembly of claim 5, wherein the first side has a first top edge and the second side has a second top edge, the first top edge and the second top edge being angled relative to the floor wherein the roof is angled between the back side and the front side.

7. The pet home assembly of claim 4, the house further comprising a plurality of interior floors being coupled to and extending between the plurality of sides to define a plurality of levels within the house.

8. The pet home assembly of claim 7, the plurality of levels comprising:
a first level being positioned adjacent to the floor;
a second level being positioned above the first level; and
a third level being positioned above the second level.

9. The pet home assembly of claim 7, the house further comprising a plurality of staircases being coupled to and extending between the plurality of interior floors, the plurality of staircases extending between the plurality of levels wherein the plurality of staircases is configured to facilitate the small animal in traveling between each of the plurality of levels.

10. The pet home assembly of claim 7, the house further comprising a plurality of holes extending through the plurality of interior floors, the plurality of holes being configured to facilitate the small animal in moving between the plurality of levels.

11. The pet home assembly of claim 7, the house further comprising a plurality of interior walls being coupled to and extending between the floor, the plurality of interior floors, and the roof to define a plurality of rooms within the house.

12. The pet home assembly of claim 11, the house further comprising a plurality of doorways extending through the plurality of interior walls, the plurality of doorways extending between the plurality of rooms wherein the plurality of doorways is configured to facilitate the small animal in moving between the plurality of rooms.

13. The pet home assembly of claim 11, the plurality of rooms further comprising:
a kitchen;
an entryway being positioned adjacent to the kitchen;
a living room being positioned above the kitchen;
a bedroom being positioned above the living room;
a bathroom being positioned above the living room; and
a hallway being positioned between the bedroom and the bathroom.

14. The pet home assembly of claim 13, the kitchen further comprising:
a food bowl being concavely arcuate across an upper surface wherein the food bowl is configured to hold food for the small animal; and
a sink being concavely arcuate across a top surface wherein the sink is configured to hold a fluid.

15. The pet home assembly of claim 14, further comprising:
an aperture extending through a side of the plurality of sides of the house into the kitchen, the aperture being aligned with the sink, the aperture being positioned above the sink, the aperture being configured to receive a spout of a water bottle wherein the sink is configured to retain the fluid when the fluid drips outwardly through the spout from the water bottle; and
a retainer being coupled to an exterior surface of the house, the retainer extending outwardly from the house wherein the retainer is configured to secure the water bottle against the house, the retainer being positioned above the aperture wherein the retainer is configured to receive the water bottle such that the spout is positionable through the aperture.

16. The pet home assembly of claim 13, the bedroom further comprising a bed being concavely arcuate across an uppermost surface wherein the bed is configured to hold a bedding material for the small animal.

17. The pet home assembly of claim 13, the bathroom further comprising:
a bathtub being concavely arcuate across a topmost surface wherein the bathtub is configured to hold a bedding material for the small animal; and
a toilet having a toilet bowl, the toilet bowl being concavely arcuate wherein the toilet is configured to hold a treat for the small animal.

18. A pet home assembly comprising:
a tank having a base wall and a peripheral wall being coupled to and extending upwardly from the base wall to define an interior space, the peripheral wall having an upper edge defining an opening into the interior space, the peripheral wall having a first pair of lateral ends and a second pair of lateral ends, the first pair of lateral ends having a length exceeding a length of the second pair of lateral ends, the peripheral wall being transparent wherein the peripheral wall is configured to facilitate visibility into the interior space;
a tray being removably positionable on the base wall of the tank, the tray having a bottom panel and a lip being coupled to and extending upwardly from the bottom panel, the bottom panel having a size being complementary to the base wall of the tank wherein the tray covers an entirety of the base wall when the tray is positioned in on the base wall of the tank, the lip having a width between 0.5 inch and 1.5 inches, the tray further comprising:
a plurality of cutouts extending through the lip, the plurality of cutouts being configured to facilitate a user in gripping the tray to position the tray in the interior space of the tank, each cutout of the plurality of cutouts being spaced from an adjacent cutout of the plurality of cutouts, each cutout being centered on a respective side of the lip, each cutout being opposite and aligned with another cutout across the bottom panel;
a plurality of magnets being coupled to the bottom panel, the plurality of magnets being spread across the bottom panel in a first lateral grouping, a central grouping, and a second lateral grouping, the central grouping being positioned between the first lateral grouping and the second lateral grouping wherein the central grouping is centrally positioned on the bottom panel of the tray;
a house being releasably couplable to the tray, the house being positionable within the interior space of the tank when the house is coupled to the tray and when the tray is positioned in the interior space, the house having a height being smaller than a height of the peripheral wall of the tank wherein the house is configured to provide a living space for a small animal within the tank, the house further comprising:
a floor being positionable to rest on the tray, the floor being releasably couplable to the bottom panel of the tray, the floor being parallel to the bottom panel of the tray when the house is coupled to the tray, the floor being magnetic wherein the floor is magnetically attracted the plurality of magnets whereby the house is magnetically secured to the tray when the floor is positioned to rest on the tray, the floor being magnetically attracted to one or more magnets of the plurality of magnets wherein the floor is adjustably positionable on the tray, the central grouping of the plurality of magnets being arranged to mirror a shape of the floor wherein the floor is configured to be magnetically secured to the central grouping of the plurality of magnets whereby the house is centrally positionable on the tray and whereby each of the first lateral grouping and the second lateral grouping of the plurality of magnets is laterally spaced from the house when the floor is coupled to the tray;
a plurality of sides being coupled to and extending upwardly from the floor, each side of the plurality of sides being perpendicular to the floor, the plurality of sides including:
a back side being parallel to the first pair of lateral ends of the tank when the house is positioned within the interior space;
a first side being coupled to and extending outwardly from the back side, the first side being perpendicular to the back side, the first side being parallel to the second pair of lateral ends of the tank when the house is positioned within the interior space;
a second side being coupled to and extending outwardly from the back side, the second side being perpendicular to the back side, the second side being parallel to the first side, the second side being spaced from the first side;
a front side being open to facilitate access and visibility into the house, the front side having a pair of forward edges being positioned on opposed sides of the front side, the pair of forward edges being coplanar with each other. the pair of forward edges being parallel to the back side;
a roof being coupled to and extending between the plurality of sides, the roof being distally positioned on the plurality of sides relative to the floor, the roof being perpendicular to each side of the plurality of sides, the roof being planar;
said first side having a first top edge, the second side having a second top edge, the first top edge being coplanar with the second top edge, the first top edge and the second top edge being angled relative to the floor wherein the roof is angled downwardly between the back side and the front side and wherein the back side has a height exceeding a height of the front side;
a plurality of interior floors being coupled to and extending between the plurality of sides to define a plurality of levels within the house, the plurality of levels including:
a first level being positioned adjacent to the floor;
a second level being positioned above the first level;
a third level being positioned adjacent to the roof, the third level being positioned above the second level;
a plurality of interior walls being coupled to and extending between the floor, the plurality of interior floors, and the roof to define a plurality of rooms within the house, the plurality of rooms being arranged on the plurality of levels wherein each level of the plurality of levels includes at least one room of the plurality of rooms, the plurality of rooms including:
a kitchen being positioned on the first level, the kitchen further comprising:
a food bowl being concavely arcuate across an upper surface wherein the food bowl is configured to hold food for the small animal;
a sink being concavely arcuate across a top surface wherein the sink is configured to hold a fluid, the sink being positioned against the first side;
a decorative refrigerator being positioned against the back side, the decorative refrigerator being configured to resemble a working refrigerator wherein the kitchen is configured to represent a working kitchen;
an entryway being positioned on the first level adjacent to the kitchen;
a living room being positioned on the second level;
a bedroom being positioned on the third level, the bedroom further comprising:
a bed being concavely arcuate across an uppermost surface wherein the bed is configured to hold a bedding material for the small animal, the bed having a size being configured to complement a size of the small animal wherein the bed is configured to hold the small animal while the small animal is resting on the bedding;
a decorative dresser being positioned against the back side, the decorative dresser being configured to resemble a working dresser wherein the bedroom is configured to represent a working bedroom;
a bathroom being positioned on the third level, the bathroom further comprising:
a bathtub being concavely arcuate across a topmost surface wherein the bathtub is configured to hold the bedding material for the small animal, the bathtub having a size being configured to complement the small animal wherein the bathtub is configured to hold the small animal while the small animal is resting on the bedding;
a toilet having a toilet bowl, the toilet bowl being concavely arcuate wherein the toilet is configured to hold a treat for the small animal;
a hallway being positioned on the third level between the bedroom and the bathroom;
a plurality of staircases being coupled to and extending between the plurality of interior floors, the plurality of staircases extending between the plurality of levels wherein the plurality of staircases is configured to facilitate the small animal in traveling between each of the plurality of levels, the plurality of staircases further comprising:
a first level staircase extending between the first level and the second level, the first level staircase extending upwardly from the entryway to the living room;
a second level staircase extending between the second level and the third level, the second level staircase extending upwardly from the living room to the hallway;
a plurality of holes extending through the plurality of interior floors, the plurality of holes being configured to facilitate the small animal in moving between the plurality of levels, the plurality of holes further comprising:
a kitchen hole being positioned on the second level above the kitchen wherein the kitchen hole is configured to facilitate the small animal in moving between the kitchen and the living room, the kitchen hole being positioned proximate to the second level staircase wherein the kitchen hole is configured to facilitate the small animal in accessing the kitchen when the small animal is descending the second level staircase;
a hallway hole being positioned on the third level within the hallway, the hallway hole being positioned proximate to the second level staircase wherein the hallway hole is configured to facilitate the small animal in accessing the second level staircase from the hallway and wherein the hallway hole is configured to facilitate the small animal in moving between the hallway and the living room;
a plurality of doorways extending through the plurality of interior walls, the plurality of doorways extending between the plurality of rooms wherein the plurality of doorways is configured to facilitate the small animal in moving between the plurality of rooms, the plurality of doorways including:
a bedroom doorway being positioned on the third level, the bedroom doorway extending between the hallway and the bedroom wherein the bedroom doorway is configured to facilitate the small animal in moving between the hallway and the bedroom;
a bathroom doorway being positioned on the third level, the bathroom doorway extending between the hallway and the bathroom wherein the bathroom doorway is configured to facilitate the small animal in moving between the hallway and the bathroom;
a plurality of windows extending through the plurality of sides, each window of the plurality of windows being configured to facilitate the small animal in crawling through the plurality of windows, the plurality of windows being positioned on the first side, the back side, and the second side, the plurality of windows further comprising:
a living room window extending through the first side, the living room window being positioned in the living room;
a bathroom window extending through the first side, the bathroom window being positioned in the bathroom;
a kitchen window extending through the back side, the kitchen window being positioned in the kitchen;
a hallway window extending through the back side, the hallway window being positioned in the hallway;
a bedroom window extending through the second side, the bedroom window being positioned in the bedroom;
an aperture extending through the first side into the kitchen, the aperture being aligned with the sink, the aperture being positioned above the sink, the aperture being configured to receive a spout of a water bottle wherein the sink is configured to retain the fluid when the fluid drips outwardly through the spout from the water bottle;
a retainer being coupled to an exterior surface of the house, the retainer extending outwardly from the house wherein the retainer is configured to secure the water bottle against the house, the retainer being positioned on the first side of the plurality of sides of the house above the aperture extending through the first side wherein the retainer is configured to receive the water bottle such that the spout is positionable through the aperture;
a plurality of yard decorations being positionable to rest on the tray, the plurality of yard decorations being releasably couplable to the bottom panel of the tray, each yard decoration of the plurality of yard decorations having a height being smaller than a height of the peripheral wall of the tank wherein the plurality of yard decorations is configured to provide entertainment for the small animal within the tank while inhibiting the small animal from escaping the tank through the opening, each yard decoration of the plurality of yard decorations being magnetic wherein each yard decoration of the plurality of yard decorations is magnetically attracted to the plurality of magnets whereby each yard decoration of the plurality of yard decorations is magnetically secured to the tray, each yard decoration of the plurality of yard decorations being magnetically attracted to one or more magnets of the plurality of magnets wherein each yard decoration of the plurality of yard decorations is adjustably positionable on the tray, the plurality of yard decorations being magnetically attracted to the first lateral grouping and the second lateral grouping of the plurality of magnets wherein each yard decoration of the plurality of yard decorations is positionable outside of the house when the house is coupled to the central grouping of the plurality of magnets; and
a lid being removably positionable over the upper edge of the peripheral wall of the tank, the lid covering the opening when the lid is positioned over the upper edge of the peripheral wall wherein the lid is configured to inhibit the small animal from exiting the tank through the opening.
